(19) United States
(12) Patent Application Publication
(10) Pub. No.: US 2010/0287292 A1
(43) Pub. Date: Nov. 11, 2010

(54) Method, apparatus and computer program product for generating a content website in a data communications network

(76) Inventor: Michael Ohman Meurlinger, Stockholm (SE)

Correspondence Address: RENNER OTTO BOISSELLE & SKLAR, LLP, 1621 EUCLID AVENUE, NINETEENTH FLOOR, CLEVELAND, OH, 44115, US

(21) Appl. No.: 12/437,924

(22) Filed: May 8, 2009

(51) Int. Cl. G06F 15/16; G06F 17/30

(52) U.S. Cl. 709/230; 707/E17.044

(57) ABSTRACT

The present invention relates to an apparatus (300) for automatically generating a content file (310) from a source (320) file, wherein the source file (320) includes reference markers (330) acting as either insertion points or content modifiers, said apparatus (300) comprising:
means (340) for retrieving the source file (320);
means (350) for extracting the reference markers (330);
a page solver (350) arranged to solve the reference markers (330) by using reference solvers (360);
means (370) for generating a content file (310) from the solved source file (320).
   The invention is also directed to a related method and a computer program product.

### TECHNICAL FIELD

The present invention relates to a method, apparatus and computer program product for generating a content website in a data communications network.

### BACKGROUND

A public data communications network such as the Internet is formed of a plurality of networks connected to each other, wherein each of the constituent networks maintains its identity. Each network supports communication among devices such as web-servers and so-called “clients”, typically local computers, connected to the public network.

A web page is accessible typically from a client via a web-server. A client uses a software, typically a so-called “web browser” (in short referred to as a “browser”) to access a web page. The browser “reads” the content and provides a presentation of the content to the client.

Typically, a website is a number of web pages having a relation to each other. These web pages could be more or less in numbers. A website is accessible through a network called the “World Wide Web” on the Internet. The web pages of a website will be accessed from a universal root called URL, a homepage or index page, and usually reside on a particular web-server. The URLs of the pages systematize them into an order.

Typically, websites are written in HTML (Hyper Text Markup Language) and is acquiescence using the web browsers, where the user could browse between the web pages. HTML is used to design the website that describes how pages of text, graphics, and other information are organized, formatted, and linked in a website. HTML pages are the standard interface to the Internet.

Typically, as briefly mentioned above, access of a website is provided by means of a client, typically in the form of a local client computer connected to the Internet. By means of a data transfer protocol such as FTP (File Transfer protocol), files are transferred to a particular web-server. A response in the form of a web page powered by the web-server is then transmitted to the client from the server. A web page could also refer to external files such as images, files describing layout such as css files, code pages such as JavaScript-files etc. External files refer to files that reside on another web-server. This could in some cases possess particular problems if a reference is no longer available.

A common problem is that web pages sometimes contain so-called “broken references”, meaning references, typically links, referring to files that are missing. This implies that the browser presents an error page indicating a missing page. In some cases, also the content of the web page could be influenced, even if a web page could be presented.

Another common problem is that website designing and implementation requires a number of competences such as designers, programmers, data base specialists etc. Typically, they use different and often incompatible types of software and tools such as graphical tools for graphical design, code editors and data base tools for handling data bases. This typically also requires different types of skills hindering one and the same person to be able to perform all of these skills. Even if one and the same person is skilled within the art, conventional website designing typically requires switching between different tools. This of course is a drawback.

Basically, there are static and dynamic web pages, of which static web pages do not change every time the page is loaded into the browser, typically they even cannot change if a user clicks on a button.

Static web pages always look the same and the content never changes unless a new page is loaded or the page is changed by the user, which uploads the new version of the pages to the server. Dynamic pages are referred to as web pages that changes dynamically. Dynamic web pages can change every time they are loaded (without a user having to make those changes) and they can change their content based on what the user does, like clicking on some text or an image. One of the most common types of dynamic web pages is the so-called “database driven” type. This means that the web page inputs information from a database (the web page is connected to the database by programming) and inserts that information into the web page each time it is loaded. If the information stored in the database changes, the web page connected to the database will also change accordingly and automatically without human intervention. Such data base driven web pages sometimes possess particular problems as regards the handling of the data bases. Typically, a conventional user cannot freely create and handle the data bases.

The “dynamical” web pages web pages could also be partially or totally generated or pre-treated on the web-server. Such web pages are capable of storing information concerning the user. Storing is typically provided in a data base connected to the web-server.

On the Internet, there are hosting providers such as web hotels that provide an environment where they could split up areas on web-servers and rent out this space, cutting the costs across many people sharing server (and backbone) connection to the Internet. A web hotel is typically controlled by a data base controller. To obtain space in a web hotel, a user becomes a member and agrees to terms and conditions of renting the space. Once a user agrees and becomes a member, he/she is typically given an access code, a key, to a user specific piece of the Internet. This key, typically in the form of a login and password, allows him to connect to the web hotel server and do a number of things, but web hotels normally hinders external connection directly to the data base controller. This implies problems with creating dynamical web pages storing information in data bases.

Cloud computing is a style of computing in which dynamically scalable and often virtualized resources are provided by hosting providers, including service providers, as a service over the Internet. Also here, the service providers running the web-servers normally hinder external connection directly to the data base controller.

A common problem is that most hosting providers and service providers block direct access to the data base for security reasons posing a number of drawbacks, in particular as regards dynamic web pages. Similar problems occur with data base driven websites.

Thus, there still exists problems with prior art to overcome.

### SUMMARY OF THE INVENTION

An aspect of the present invention is to provide a method for automatically generating a content file from a source file, wherein the source file includes reference markers acting as either insertion points or content modifiers, said method comprising the steps of:
retrieving the source file;
extracting the reference markers;
solving the reference markers by using reference solvers;
generating a content file from the solved source file; and optionally
transferring the content file and the related files to a target location.

According to another aspect of the present invention, there is provided an apparatus for automatically generating a content file from a source file. The source file includes reference markers acting as either insertion points or content modifiers. The apparatus comprises:
means for retrieving the source file;
means for extracting the reference markers;
a page solver arranged to solve the reference markers by using reference solvers;
means for generating a content file from the solved source file.

Herein, the term “content file” is referred to a file containing everything such as high level code, binary image data, or more than one file.

An advantage of the present invention is that a website could be regarded as one web page instead of a number of web pages linked together, having no direct relation to each other. If a web page is transferred and/or changed, the present invention updates all links and all graphics dynamically. In this way, website designing is much faster and user-friendly. For instance, by means of the present invention it is easy to re-design a website compared to conventional technology because there is only one user interface (tool) instead of several required. The appearance of the user interface (tool) is very logical to a user. The tool could typically be regarded as a “master tool” providing all functions, such as updating links to other pages, menus etc, at the same time. Moreover, the present invention corrects broken references if such are present, i.e. to update or delete non-active links if content has been moved or removed.

A reference marker could be a link reference to another content file and the reference solver could solve broken links by using a method further comprising the steps of
classifying the broken link according to one or more decision parameters;
If required adapting the content of the web page according to the classification, such that any broken reference(s) are corrected.

In this way, no broken references could be present and all content is updated automatically.

According to another aspect of the present invention, the generation of data could be based on metadata added to the web page and variables being depending on the context (content). The metadata could also contain references where data is received from external servers, for instance data could be received by means of direct or indirect connection to a data base controller.

Typically, the method further comprises the step of automatically generating data depending on the structure of the web page, or thereto related website, metadata of the website and variables depending on the context.

The metadata could also contain references where data is provided by means of external servers. This has the advantage that the metadata also could be provided by direct or indirect connection to a data base controller.

Herein, the term “metadata” includes any data about data, including locations of data and processes, access methods, limitations, timing and events, as well as rules. Thus, the term “metadata” should be regarded broad in definition.

Yet another aspect of the present invention is to indirectly create, change and configure data bases and data base objects without a direct connection to the data base controller by firstly transferring a file having control instructions to the web-server by means of a data transfer protocol such as FTP and SFPT, and subsequently perform control functions by means of calling via a web protocol such as HTTP.

There is also provided a computer program product comprising in a computer executable code means, when loaded into the computer to perform the method or implement the apparatus.

### BRIEF DESCRIPTION OF THE DRAWINGS

The features and advantages of the present invention as described and additional ones will become further apparent from the following detailed description and the accompanying drawings, of which:

FIG. 1 illustrates a system for presenting web pages on a website in general;

FIG. 2 illustrates a flow chart of a method for generating a content website in a data communications network according to an embodiment of the present invention;

FIG. 3 illustrates a system including an apparatus for generating a content website in a data communications network according to an embodiment of the present invention;

FIG. 4 an automatic process for correcting broken links for presentation;

FIG. 5 illustrates an automatic process for generating images;

FIG. 6 illustrates an automatic process for generating content based on the structure of the website;

FIG. 7 illustrates indirect communication with a data base, and

FIG. 8 illustrates example with a menu reference marker.

### DETAILED DESCRIPTION OF THE INVENTION

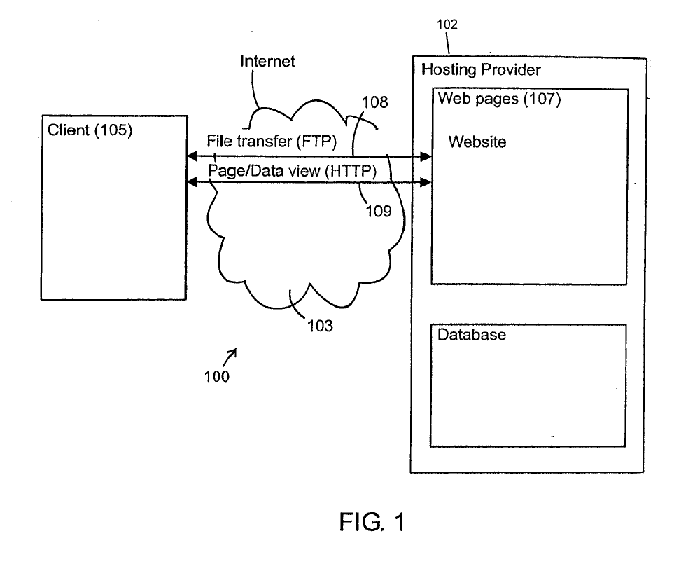

Now is first referred to FIG. 1 illustrating a system 100 for presenting web pages on a website 107 in general into which the invention could be implemented. The system 100 comprises a web-server 102, herein a so-called “hosting provider”, connected to a data communications network 103, herein the Internet. The hosting provider could be any type of hosting provider such as a web hotel or a data base driven website. The server 102 has an interface to the network 103 providing a client 105 having an interface to the network 103, the client herein being an external computer, 105 to connect to the server 102 through the interface and via the intervening network 103. In this way, the client 105 could exchange information with the web-server 102, such that the website 107 (containing web pages) are accessible for the client 105 by means of the web-server 102. The client 105 uses a web browser (not shown), which is particular software for presenting web pages on a client, to access a web page. The browser “reads” a content of a web page 107 and provides a presentation of the content on the client 105 (typically on a display (not shown) thereof). Typically, the web pages 107 are written in HTML (Hyper Text Markup Language) and are accessible using the web browser, where a user by means of the client 105 could browse between the web pages 107. Typically, HTML has been used to design the website 107 (a number of interconnected web pages) that describes how pages of text, graphics, and other information are organized, formatted, and linked in a website. FIG. 1 also illustrates how the client 105 has access to the hosting provider's server, i.e. the web-server 102 by means of using a File Transfer protocol (FTP) and HTTP-protocol. The files for the website 107 are transferred to the corresponding web-server 102 providing the website 107 using FTP 108. Responding HTTP-files 109 are then transferred back to the client 105. Of course, the invention is by no means limited to the particular type of network (the Internet) and the protocols described, FTP and HTTP, since these are only examples.

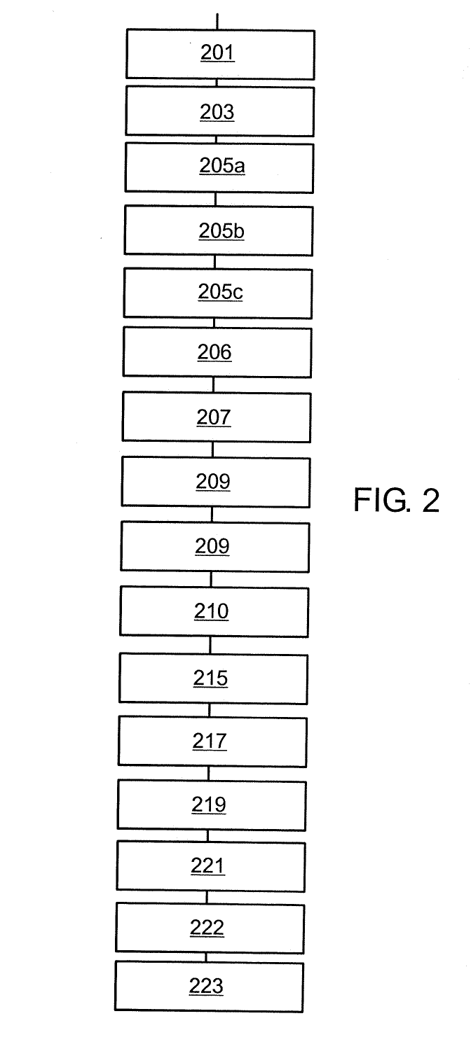

Now is referred to FIG. 2 illustrating a flow chart of a method for automatically generating a content file from a source file, which includes reference markers acting as either insertion points or content modifiers in a data communications network according to an embodiment of the present invention.

In a first step, the source file is retrieved, step 201. Then in a second step, the reference markers are extracted, step 203, followed by solving the reference markers by using reference solvers, step 205a, generating a content file from the solved source file, step 207 and transferring the content file and the related files to a target location, step 209. The last step, step 209 is optionally and could in some cases be left out.

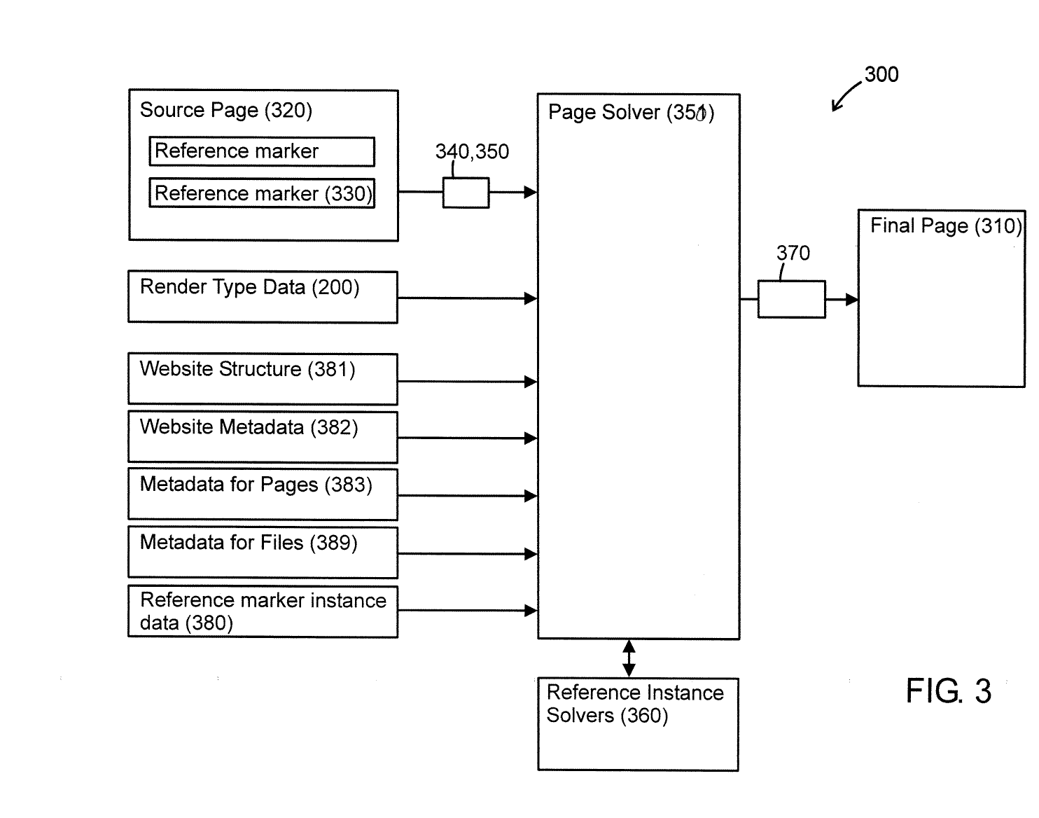

FIG. 3 illustrates a system including an apparatus 300 for automatically generating a content file 310 (herein a final page) from a source file 320 for performing the method as described above according to an embodiment of the present invention. The apparatus 300 comprises:
means 340 for retrieving the source file 320;
means 350 for extracting the reference markers 330;
a page solver 350 arranged to solve the reference markers 330 by using reference solvers 360; and
means 370 for generating a content file 310 from the solved source file 320.

All of these functional means 340, 350, 360 and 370 are obvious for a person skilled in the art to design and implement for instance by programming. Because of that, they or their implementation will not be described in more detail.

The source file (herein a source page) 320 can include one or more reference markers 330 which act as either one or more insertion points or modifiers of content. The source file 320 may also include further information. The reference markers 330 can either directly include instance data for the reference, being a so-called “self-contained reference marker”, refer to reference marker instance data 380 or be a mixture of both. The page solver 350 creates the content page 310 by solving the reference markers. To solve a reference the page solver 350 has as input the website structure 381, the website metadata 382, metadata for all pages 383 and metadata for files 384. Of course, in some cases not all of these inputs are required. They are only intended to exemplify a particular structure. A reference 330 is solved (in a similar way) by a reference instance solver 360. Typically, the reference instance solver 360 is selected depending on the reference type. The reference instance solver 360 is optional and just an example.

The method and apparatus could be completely or partly implemented by means of software, typically in the form of a computer program product comprising computer code means stored on a data carrier or being directly loadable into a computer.

An advantage of the present invention is that a website could be regarded as one web page instead of a number of web pages linked together, having no direct relation to each other. If a web page is transferred and/or changed, the present invention updates all links and all graphics dynamically. In this way, a user could easily and fast handle website layout including all web pages simultaneously operating from only one user interface or using one tool.

Another advantage is that the method and apparatus according to the present invention corrects broken references if such are present, i.e. to update or close links if content has been moved or removed.

According to an embodiment of the present invention, the method then typically comprises the steps of
analyzing the content of a web page;
providing a list of broken references to files or sources;
classifying the broken references according to one or more decision parameters;
if required adapting the content of the web page according to the classification, such that any broken reference(s) are corrected.

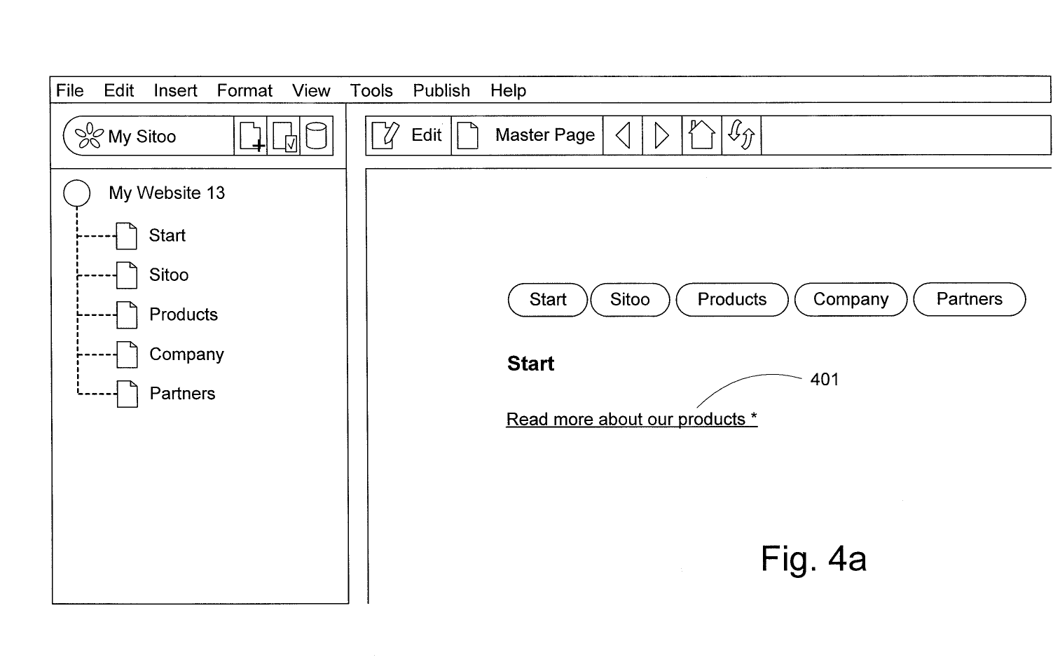

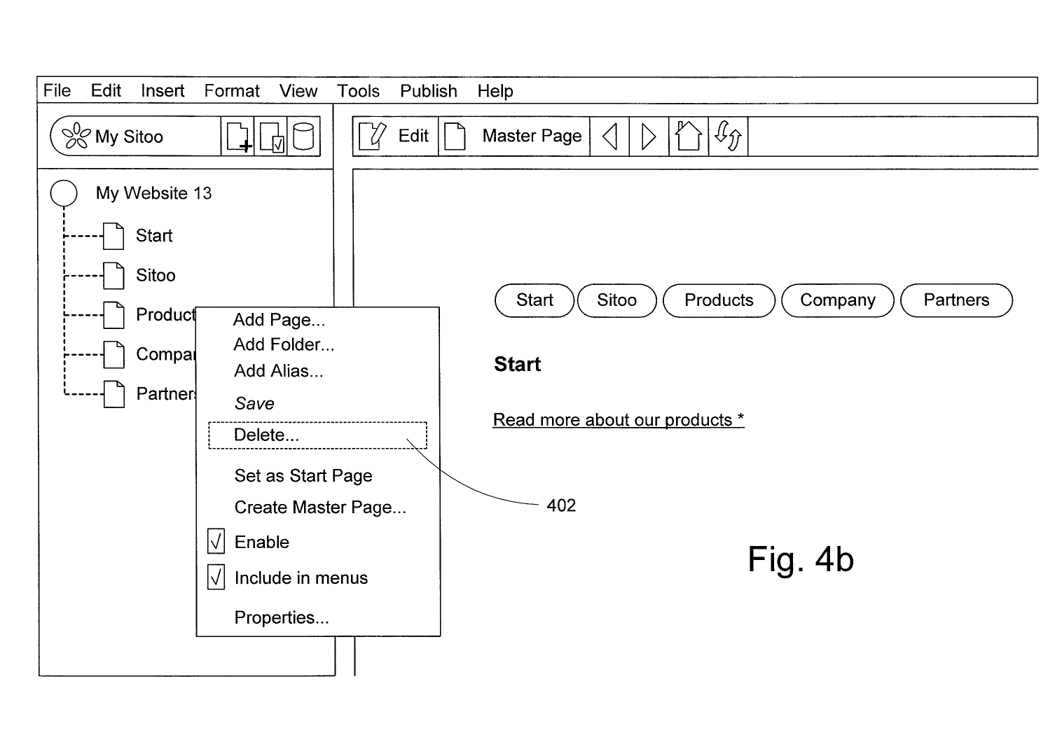

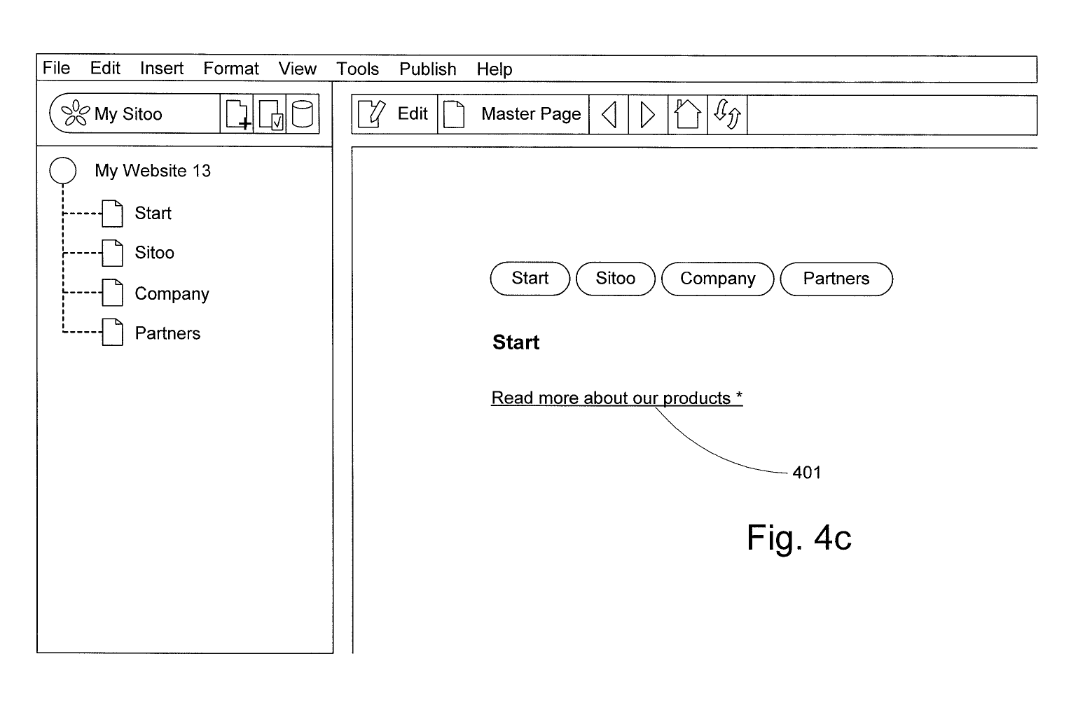

Now is referred to FIG. 4, which illustrates an automatic process for correcting broken references, herein links for publication. This figure describes how web pages are pre-treated before publication, i.e. before they are transmitted to the web-server, wherein broken links are automatically corrected.

This process is illustrated in FIG. 4a-c, in which FIG. 4a shows how a link 401 is added to a start page linking to a page about products “Read more about products”. In FIG. 4b it is shown how the product page is removed by selecting a delete function 402 deleting the boxes “enabled” and “include in menus”. In FIG. 4c it is shown that the link has been removed since the link 401 is not active any more.

Typically, the content file generated is a web-page, step 207. The web page can be viewed directly in a web browser and uses Extensible Hypertext Markup Language (XHTML) or Hypertext Markup Language (HTML) to describe its content. This is an advantage because it is so simple for the user. The present invention provides a method and apparatus to automatically generate graphics and links based on a logical user-friendly tree structure, typically automatically.

The client 105 could for instance be a local client computer, a work station, a terminal, a handheld communication device such as a PDA, or other handheld PC device, or a digital electronic storage. Thus, the term, “client” should be non-limited to a computer only.

Now is referred back to FIG. 2.

The method could comprise the step of generating additional related files which are needed by the content file, step 206.

The content file could also, or alternatively, be preprocessed on a web-server before being transferred to a web browser. Typically, preprocessing is performed with server-side scripts or server-side programming languages. In this way, the content file could be used as part of a service for instance in a computer cloud. In particular, the method and/or apparatus could be provided as a service located on servers in a data center such as a computer cloud.

Another aspect of the present invention is to provide automatic generation of data to a web page for handling and correcting broken references by means of pre-treating web pages including analyzing all references, for instance links. In particular, an object of the present invention is to provide this locally on a client computer, typically as a software implementation. The software could connect to a web-server to publish the website. Moreover, the software could automatically handle data bases on the web-server to create dynamical websites, i.e. websites where information about the visitors could be stored.

In one embodiment, typically in a first step, in the client computer, the content of a web page is analyzed, step 201. Then, in a second step, a list of broken references to files or sources, is provided, step 203. Then, a third step, the broken references are listed according to one or more decision parameters, step 205.

The reference marker could be a link reference to another content file and the reference solver could solve broken links by using a method comprising the steps of:
classifying the broken link according to one or more decision parameters, step 205b;
If required adapting the content of the web page according to the classification, such that any broken reference(s) are corrected, step 205c.

The reference marker could also be an object reference marker and the reference solver an object content builder, wherein the object content builder automatically generates content by performing the steps of:
examining reference marker instance data, step 203;
generating content, step 207;
inserting or modifying content, step 210.

In this embodiment, the reference solver could be an image solver determining which template should be used for instance.

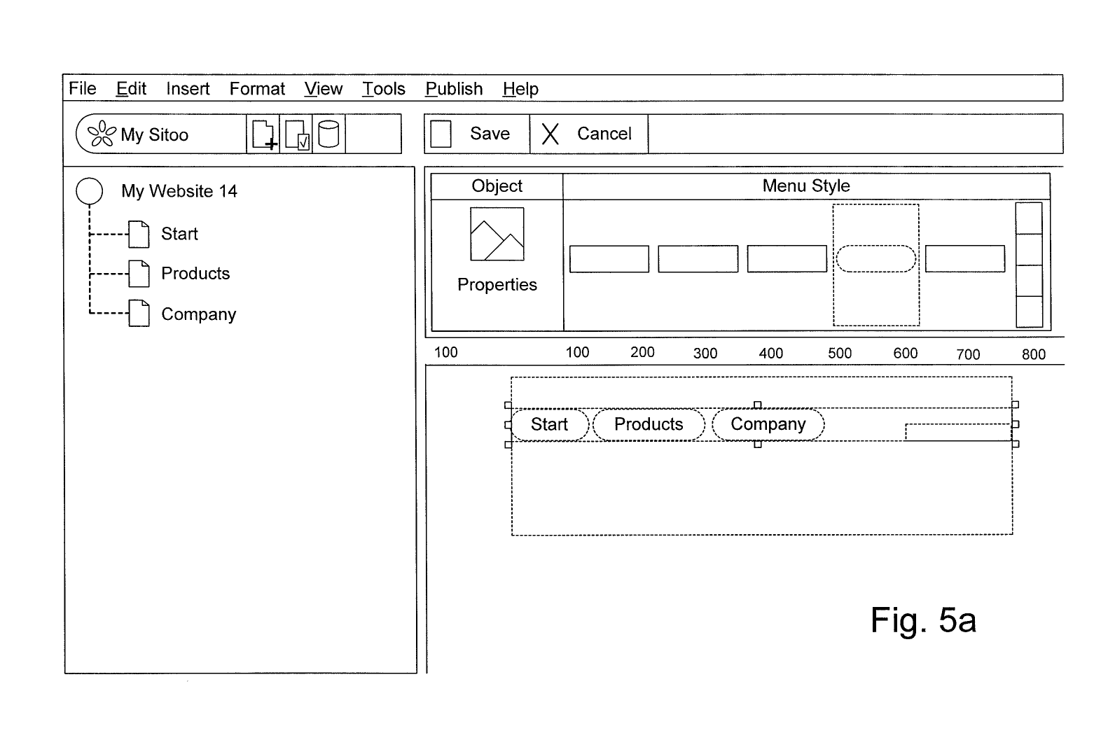

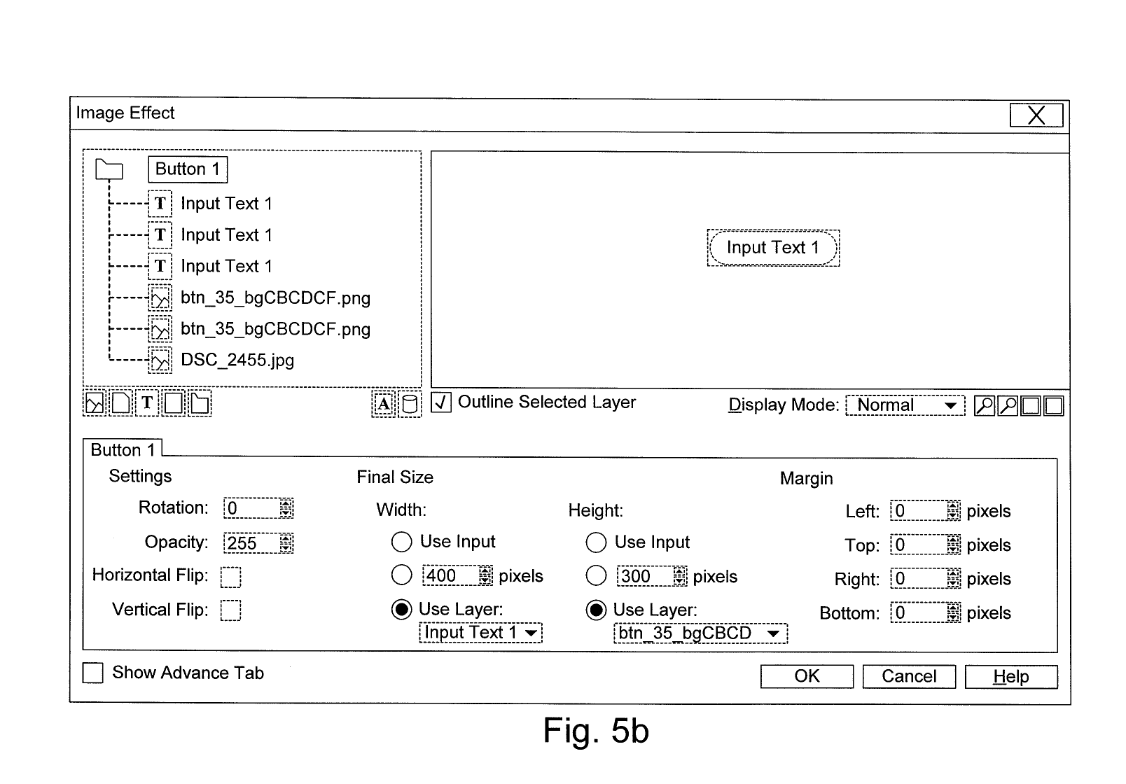

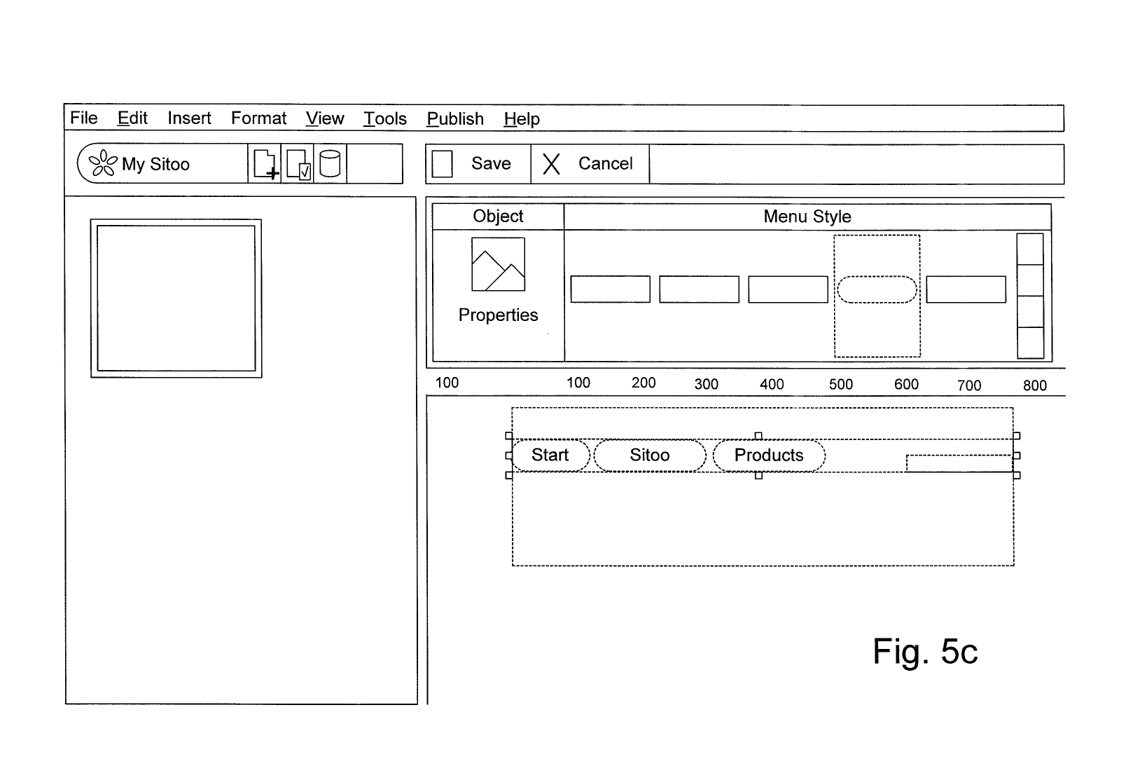

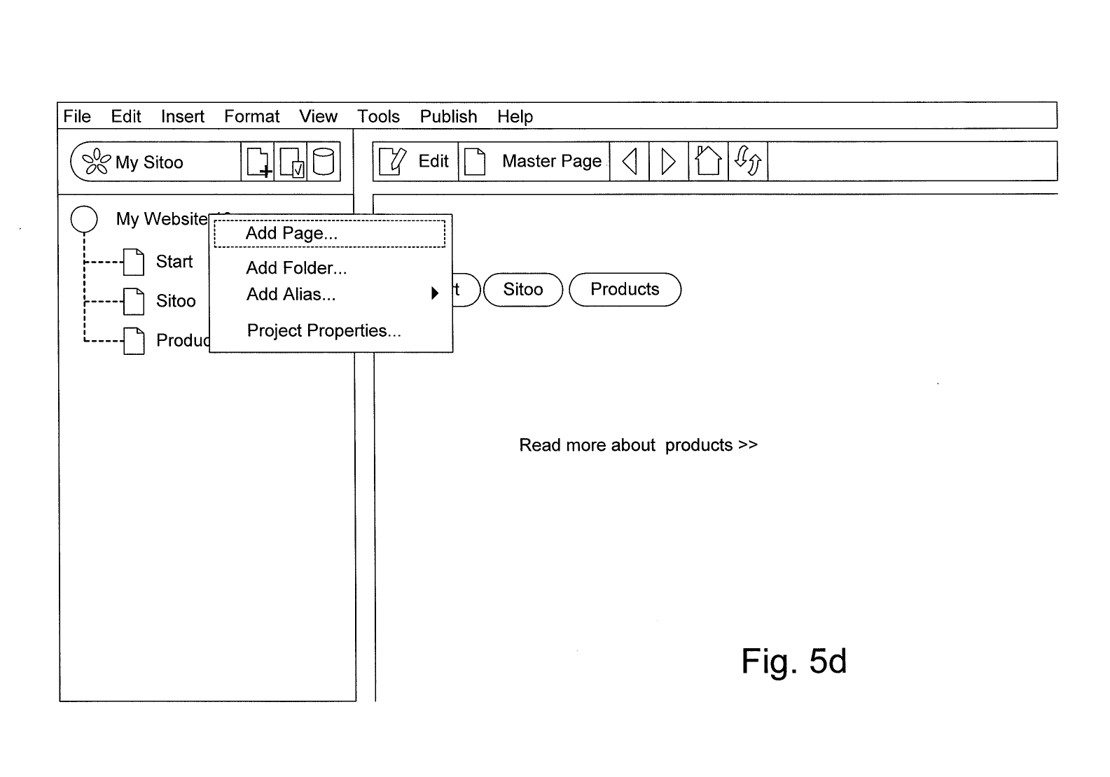

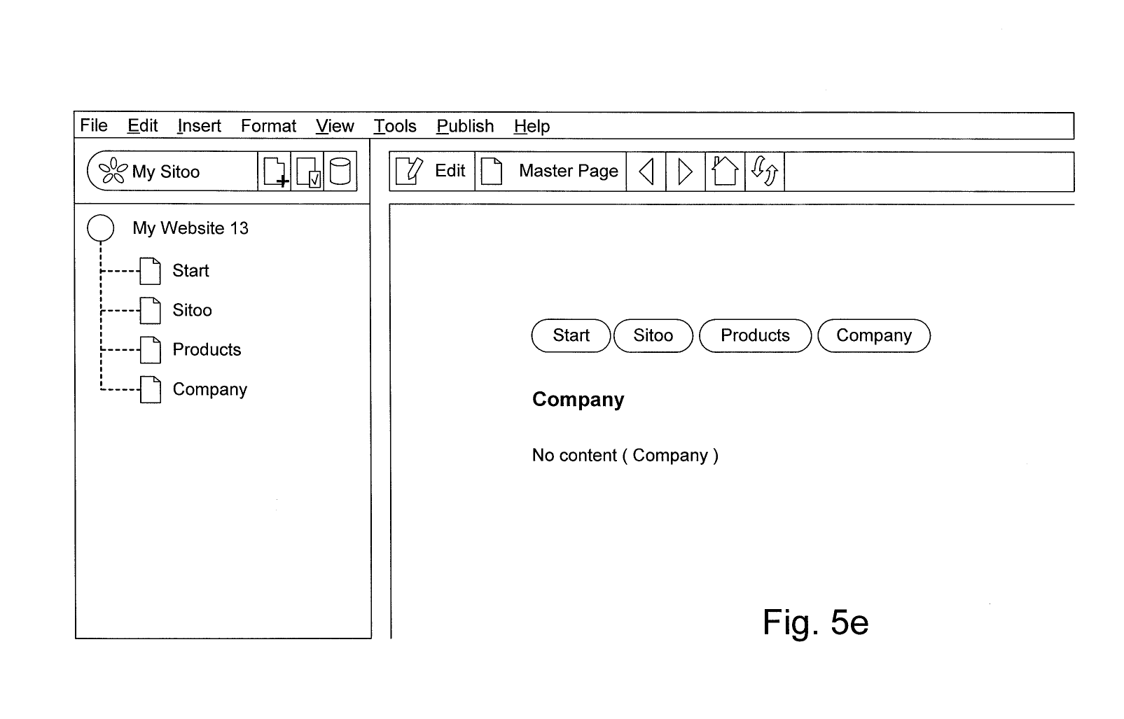

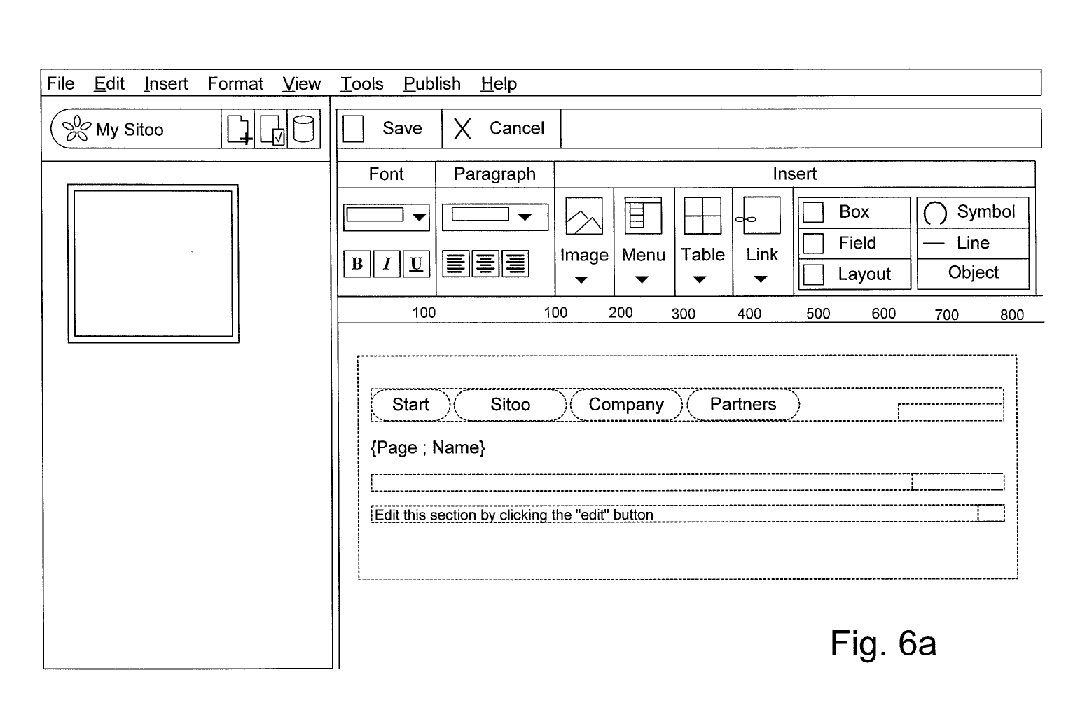

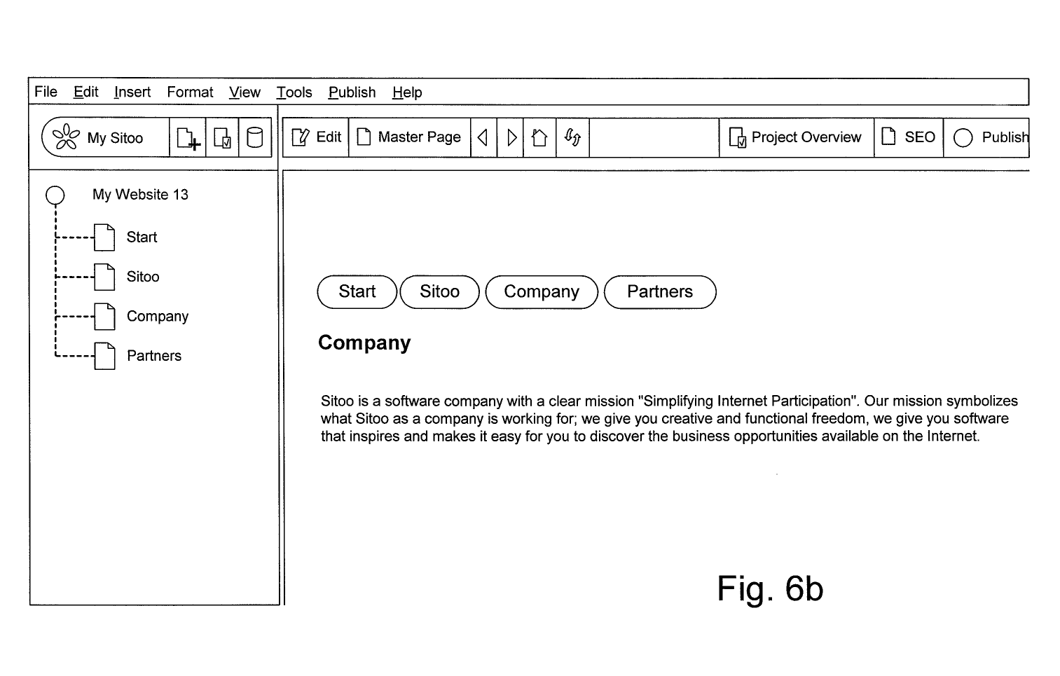

Now is referred to FIG. 5, which describes an automatic process for generating images. It is shown how images are generated automatically. In the content, there is an image reference (pointer), referring to an image template describing how the image should be set up. In addition to the pointer, there is metadata concerning the web page and the structure of the website. Metadata could for instance be the name of the web page or of the menu. By means of the pointer, the variables dependent on the context could be determined. Different pointers referring to one and the same image template could generate different images by means of the variables dependent on the context. An example of this is to generate graphical menus which are different from each other on every web page. The pointer's position on the website, for instance on which web page the pointer is on, provides variables that are dependent on context.

This is illustrated in FIG. 5a-d, of which FIG. 5a illustrates inserting menu and select image for menu, FIG. 5b illustrates editing image for menu, FIG. 5c automatic edited image for menus for all menus selected and FIG. 5d illustrates adding new page and menu image automatically.

The method could further comprise the step of:
generating related files by invoking other reference solvers, step 215.

The object reference could be a menu reference and the object content builder could be a menu builder, wherein the menu builder either a graphical menu (images) or a text menu is generated by the menu builder. In this way, components could be provided such as HTML for menu pages etc.

The menu could be built by using a method comprising the steps of:
solving the menu item hierarchy by using the reference marker instance data, step 217;
generating images for menu item which should be graphical by invoking the reference solver to solve images, step 219.

In this way, a multi-layer hierarchy could be created, typically in the form of a logical tree-structure.

Typically, the data is generated depending on the structure of the web page, or thereto related website, metadata of the website and variables depending on the context.

According to yet another embodiment of the present invention, the method further comprises the steps of:
identifying one or more metadata section(s), step 221;
analyzing content of metadata sections, step 222;
performing a procedure based on the step of analyzing metadata to provide data to be inserted into the web page, step 223.

Metadata can be stored either internally, in the same file as the data, or externally, in a separate file. Metadata that are embedded with content is called embedded metadata. A data repository typically stores the metadata detached from the data. Both ways have advantages and disadvantages:

Internal storage allows transferring metadata together with the data it describes; thus, metadata is always at hand and can be manipulated easily. This method creates high redundancy and does not allow holding metadata together.

External storage allows bundling metadata, for example in a database, for more efficient searching. There is no redundancy and metadata can be transferred simultaneously when using streaming.

Metadata can either describe the resource itself (for example, name and size of a file) or the content of the resource. An example of metadata is the name of the web page or of a menu.

The transmission of the template does not necessarily need to wait until the last step is finalized. It could start before and thus be transmitted in a streamed fashion.

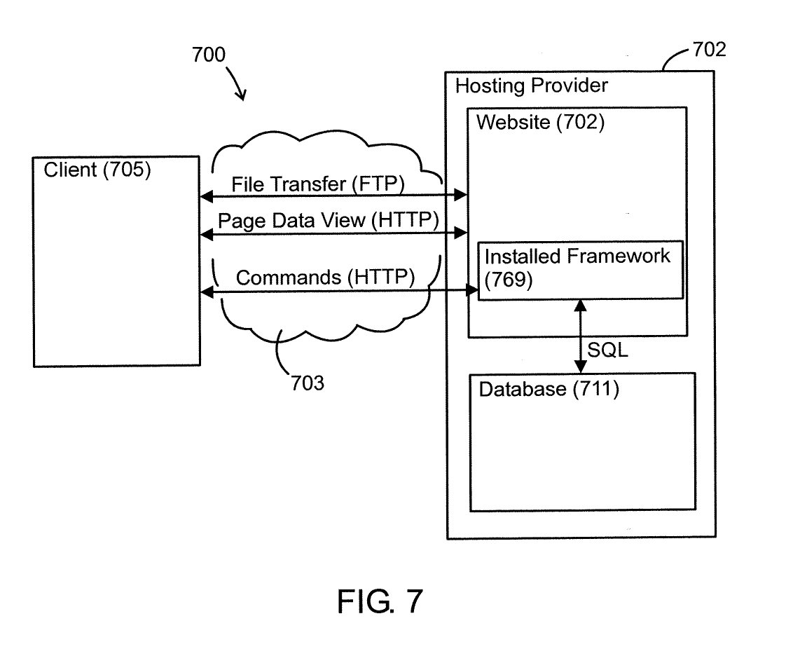

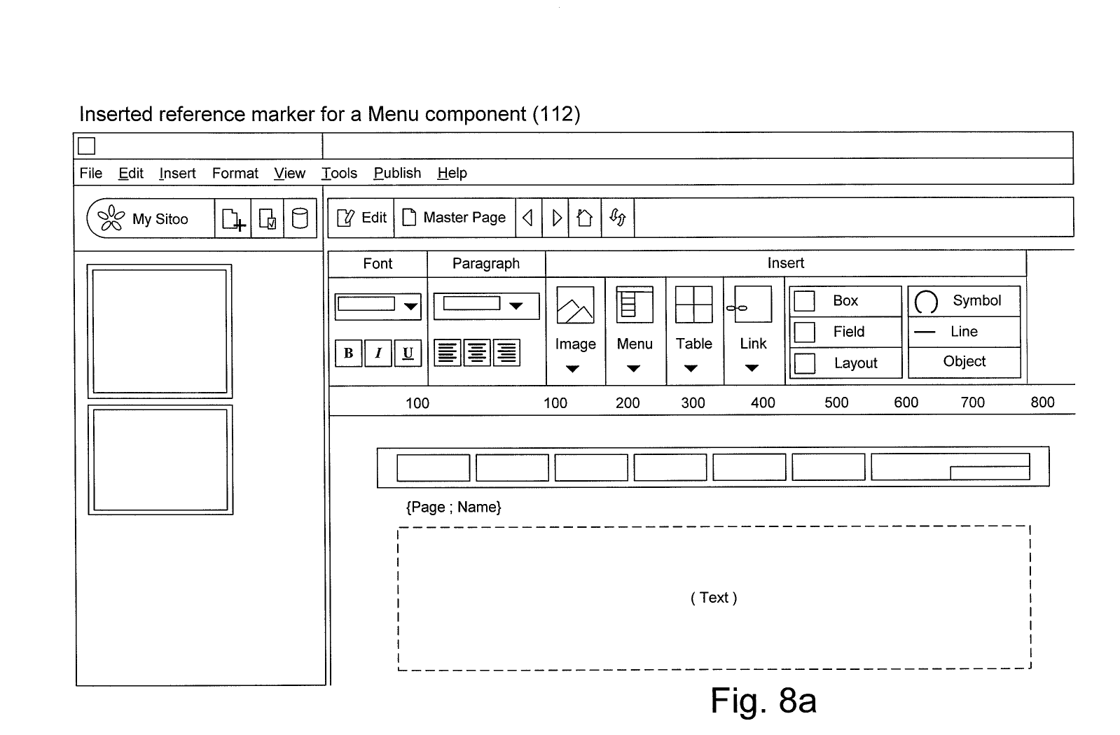

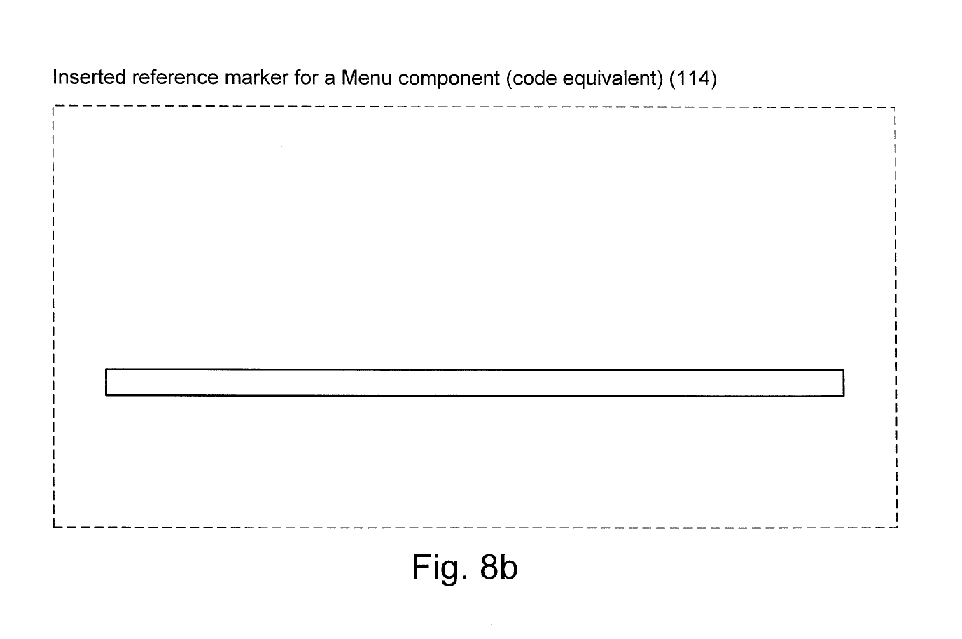

FIG. 7 illustrates indirect communication with a data base. The system 700 comprises a web-server 702, herein a so-called “hosting provider”, connected to a data communications network 703, herein the Internet. The server 702 has an interface to the network 703 providing a client 705, herein an external computer, 705 to connect to the server 702 through the interface and via the intervening data communications network 703. The client 705 has access to the hosting provider's server 702 using a file transfer protocol (FTP) and HTTP-protocol. The files for the website 707 are transferred to the web-server using FTP. An additional frame work 709 with server-side script/programming language is also transferred. The framework can communicate with the data base 711 using functions provided by the server-side script/programming language. The client 705 then calls the installed frame work 709 using HTTP which executes framework functions on the web-server 702. The framework then performs the necessary action on the data base 711 to complete the command. The framework then sends a response to the client 705.

According to a second embodiment of the present invention, there is provided a method for automatically installing a data base or data base object in a data base controller. The method comprises the steps of:
transferring a file containing program instructions to a web-server by means of a file transfer protocol such as FTP and SFPT;
running a procedure manipulating data bases and data base objects by means of sending a request to the web-server by means of a web protocol such as http.

In this way, it is possible to provide dynamical services enabling automatic connection to the website sever and by means of file transferring and calling the web-server determine type of system and system configuration. The present invention is able to automatically install data base objects and the complete frame work to provide dynamic services on the website. The present invention is able to interact with the frame work to provide a simple visual interface to the user to provide dynamic websites.

In this way, it is easy to indirectly create, change and configure data bases and data base objects without a direct connection to the data base controller by firstly transferring a file having control instructions to the web-server by means of a data transfer protocol such as FTP and SFPT, and subsequently perform control functions by means of calling via a web protocol such as HTTP.

This solves the common problem with most hosting providers and service providers blocking direct access to the data base for security reasons posing a number of drawbacks, in particular as regards dynamic web pages.

The foregoing detailed description is intended to illustrate and provide easier understanding of the invention, and should not be construed as limitations. Alternative embodiments will become apparent to those skilled in the art without departing from the spirit and scope of the present invention.

1. A method for automatically generating a content file from a source file, wherein the source file includes reference markers acting as either insertion points or content modifiers, said method comprising the steps of:
retrieving the source file;
extracting the reference markers;
solving the reference markers by using reference solvers;
generating a content file from the solved source file.

2. The method according to claim 1, further comprising the step of:
transferring the content file and the related files to a target location.

3. The method according to claim 1, comprising the step of generating additional related files which are needed by the content file.

4. The method according to claim 1, wherein a web page is generated as a content file.

5. The method according to claim 1, wherein the web page is preprocessed on a web-server before being transferred to a web browser.

6. The method according to claim 4, wherein preprocessing is performed with server-side scripts or server-side programming languages.

7. The method according to claim 1, wherein the reference marker is a link reference to another content file and the reference solver solves broken links by using a method comprising the steps of:
classifying the broken link according to one or more decision parameters;
If required adapting the content of the web page according to the classification, such that any broken reference(s) are corrected.

8. The method according to claim 1, wherein the reference marker is an object reference and the reference solver is an object content builder, wherein the object content builder automatically generates content by performing the steps of:
examining reference marker instance data;
generating content;
inserting or modifying content.

9. The method according to claim 7, further comprising the step of:
generating related files by invoking other reference solvers.

10. The method according to claim 5, wherein the object reference is a menu reference and the object content builder is a menu builder, wherein the menu builder either a graphical menu (images) or a text menu is generated by the menu builder.

11. The method according to claim 9, wherein the menu is built by using a method comprising the steps of:
solving the menu item hierarchy by using the reference marker instance data;
generating images for menu item which should be graphical by invoking the reference solver to solve images.

12. The method according to claim 1, wherein the content is generated as server-side scripts or server-side programming languages.

13. The method according to claim 1, wherein the method is provided as a service located on servers in a data center such as a computer cloud.

14. The method according to claim 1, wherein the data is generated depending on the structure of the web page, or thereto related website, metadata of the website and variables depending on the context.

15. The method according to claim 1, wherein basic information controlling set up of the web page is stored in a template containing a set of instructions.

16. The method according to claim 1, wherein data is generated on a client computer before transferring files to the server.

17. The method according to claim 1, further comprising the steps of:
identifying one or more metadata section(s);
analyzing content of metadata sections;
performing a procedure based on the step of analyzing metadata to provide data to be inserted into the web page.

18. The method according to claim 1, further comprising automatically installing a data base or data base object in a data base controller, said method comprising the steps of:
transferring a file containing program instructions to a web-server by means of a file transfer protocol such as FTP and SFTP;
running a procedure manipulating data bases and data base objects by means of sending a request to the web-server by means of a web protocol such as http.

19. An apparatus for automatically generating a content file from a source file, wherein the source file includes reference markers acting as either insertion points or content modifiers, said apparatus comprising:
means for retrieving the source file;
means for extracting the reference markers;
a page solver arranged to solve the reference markers by using reference solvers;
means for generating a content file from the solved source file.

20. A computer program product comprising in a computer executable code means, when loaded into the computer to perform the method according to claim 1.
